(19) United States
(12) Patent Application Publication
(10) Pub. No.: US 2018/0046129 A1
(43) Pub. Date: Feb. 15, 2018

(54) DEVELOPMENT CARTRIDGE AND ELECTROPHOTOGRAPHIC IMAGE FORMING APPARATUS ADOPTING THE SAME

(71) Applicant: S-PRINTING SOLUTION CO., LTD., Suwon-si (KR)

(72) Inventors: Yun-kyu SIM, Seoul (KR); Young-chae Kim, Seoul (KR); Gun-soo Chang, Seoul (KR); Ho-jin Jang, Suwon-si (KR)

(73) Assignee: S-PRINTING SOLUTION CO., LTD., Suwon-si (KR)

(21) Appl. No.: 15/441,380

(22) Filed: Feb. 24, 2017

(30) Foreign Application Priority Data
Aug. 9, 2016 (KR) 10-2016-0101223

(51) Int. Cl. G03G 15/08

(52) U.S. Cl. CPC G03G 21/1647; G03G 21/1676

(57) ABSTRACT

Provided is a development cartridge capable of being detachably attached to a main body of an image forming apparatus, the development cartridge including a developing roller; a driving power receiving member configured to rotate in a first direction or a second direction by receiving a driving power from the main body; and a power delivery member configured to connect the driving power receiving member to the developing roller and to deliver only torque of the driving power receiving member in the first direction to the developing roller.

### CROSS-REFERENCE TO RELATED APPLICATION

This application claims the benefit of Korean Patent Application No. 10-2016-0101223, filed on Aug. 9, 2016, in the Korean Intellectual Property Office, the disclosure of which is incorporated herein in its entirety by reference.

### BACKGROUND

### 1. Field

The present disclosure is related to an electrophotographic image forming apparatus for forming an image on a recording medium in an electrophotographic manner, and a development cartridge capable of being detachably attached to the electrophotographic image forming apparatus.

### 2. Description of the Related Art

An electrophotographic image forming apparatus operating in an electrophotographic manner prints an image onto a recording medium by forming a visible toner image on a photosensitive body by supplying a toner to an electrostatic latent image formed on the photosensitive body, transferring the toner image to the recording medium, and fixing the transferred toner image onto the recording medium. A development cartridge contains a toner (developer) and includes a developing roller that supplies the toner to the electrostatic latent image formed on the photosensitive body.

During an image forming operation, the photosensitive body and the developing roller rotate in a specific direction (a forward direction), and a power connection structure with a driving source is implemented by taking into account a rotation direction of the photosensitive body and the developing roller. If required, the photosensitive body may be driven in a direction (a reverse direction) opposite to the rotation direction during the image forming operation. If a rotation direction of the driving source is changed to drive the photosensitive body in the reverse direction, the developing roller is also driven in the reverse direction. When the developing roller is repeatedly driven in the forward direction and the reverse direction, the toner in the development cartridge may be leaked externally.

### SUMMARY

Provided are a development cartridge capable of regulating rotation of a developing roller, and an electrophotographic image forming apparatus employing the development cartridge.

Additional aspects will be set forth in part in the description which follows and, in part, will be apparent from the description, or may be learned by practice of the presented embodiments.

According to an aspect of an embodiment, a development cartridge capable of being detachably attached to a main body of an image forming apparatus includes a developing roller; a driving power receiving member configured to rotate in a first direction or a second direction by receiving a driving power from the main body; and a power delivery member configured to connect the driving power receiving member to the developing roller and to deliver only torque of the driving power receiving member in the first direction to the developing roller.

The power delivery member may include a rotational member including a first latch, and configured to be rotated by the driving power receiving member and to axially reciprocate between a first position and a second position when the driving power receiving member rotates in the first direction and the second direction, respectively; and a delivery member including a second latch having a form that is complementary with a form of the first latch, and configured to deliver the torque of the driving power receiving member in the first direction to the developing roller in such a manner that the first and second latches are connected to each other when the rotational member is positioned at the first position.

The first latch may include a female screw, the second latch may include a male screw corresponding to the female screw, and when the driving power receiving member rotates in the first direction, the female screw and the male screw may be coupled to each other so that the developing roller rotates, and when the driving power receiving member rotates in the second direction, the female screw and the male screw may be decoupled from each other so that the developing roller does not rotate.

The delivery member may be combined with a rotation axis of the developing roller.

The delivery member may include a rotation axis of the developing roller, wherein the male screw is formed at a side of the rotation axis.

The driving power receiving member may include a first gear, the rotational member may include a second gear coupled to the first gear, and the first and second gears may be helical gears that generate thrust in a direction toward where the rotational member is moved to the first position when the driving power receiving member rotates in the first direction.

The delivery member may be combined with a rotation axis of the developing roller, the first and second latches may have concavo-convex shapes that are complementary in the axial direction, so that the first and second latches are engaged with each other when the rotational member is positioned at the first position, and the first and second latches may be spaced apart from each other when the rotational member is positioned at the second position, the driving power receiving member may include a first gear, the rotational member may include a second gear coupled to the first gear, and the first and second gears may be helical gears that generate thrust in a direction toward where the rotational member is moved to the first position when the driving power receiving member rotates in the first direction.

The power delivery member may include a first rotational member configured to be combined with the developing roller, and including a guiding portion and a latch; a second rotational member configured to be mounted on a same axis as the first rotational member and to rotate by being coupled to the driving power receiving member, and including an inner gear; and a latch gear configured to be mounted at the guiding portion while being engaged with the inner gear, so that, when the driving power receiving member rotates in the first direction, the latch gear moves along the guiding portion to an engaged position where the latch gear is to be engaged with the latch so as to allow the first rotational member and the second rotational member to rotate together, and when the driving power receiving member rotates in the second direction, the latch gear moves along the guiding portion to a disengaged position where the latch gear is spaced apart from the latch.

The development cartridge may further include a photosensitive drum configured to form a development nip by contacting the developing roller; and a development nip releasing member configured to move the developing roller to be spaced apart from the photosensitive drum to release the development nip when the driving power receiving member rotates in the second direction.

When the driving power receiving member rotates in the first direction, the development nip releasing member may move the developing roller to contact the photosensitive drum to form the development nip.

The development cartridge may further include a stirring chamber containing developer; and a stirrer provided in the stirring chamber so as to stir the developer, wherein the stirrer is driven by being connected to the driving power receiving member.

The stirring chamber may include first and second stirring chambers that extend in a longitudinal direction of the developing roller and have interconnected ends to form a circulation path, and the stirrer may include first and second stirrers that are respectively provided in the first and second stirring chambers so as to deliver the developer in opposite directions to each other.

According to an aspect of another embodiment, an electrophotographic image forming apparatus includes a main body; and the development cartridge, the development cartridge being capable of being detachably attached to the main body.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration diagram illustrating an electrophotographic image forming apparatus, according to an embodiment;

FIG. 2 is a side view of one of development cartridges, according to an embodiment;

FIG. 3 is an exploded perspective view of a power delivery member, according to an embodiment;

FIGS. 4A through 4D illustrate operations of the power delivery member shown in FIG. 3;

FIG. 5 is an exploded perspective view of a power delivery member, according to another embodiment;

FIGS. 6A through 6D illustrate operations of the power delivery member shown in FIG. 5;

FIG. 7 is an exploded perspective view of a power delivery member, according to another embodiment;

FIG. 8 is an exploded perspective view of a power delivery member, according to another embodiment;

FIG. 9 illustrates a coupler that rotates in a first direction in the embodiment of the power delivery member of FIG. 8;

FIG. 10 illustrates the coupler that rotates in a second direction in the embodiment of the power delivery member of FIG. 8;

FIGS. 11 and 12 are side views of the development cartridge, according to an embodiment, in which FIG. 11 illustrates a state in which a photosensitive drum and a developing roller contact each other so that a development nip is formed, and FIG. 12 illustrates a state in which the photosensitive drum and the developing roller are spaced apart from each other so that the development nip is released;

FIGS. 13 and 14 are side views of the development cartridge, according to an embodiment, in which FIG. 13 illustrates a state in which a developing unit is positioned at a development position, and FIG. 14 illustrates a state in which the developing unit is positioned at a release position;

FIG. 15 is a schematic configuration diagram illustrating an electrophotographic image forming apparatus, according to another embodiment;

FIG. 16 illustrates a partial cross-sectional view of a development cartridge, according to an embodiment; and

FIG. 17 illustrates a partial perspective view of the development cartridge, according to an embodiment.

### DETAILED DESCRIPTION

The present disclosure will be described in detail by explaining embodiments of an electrophotographic image forming apparatus and a development cartridge with reference to the attached drawings. Throughout the specification and drawings, those elements performing substantially the same function are rendered the same reference numeral, and redundant explanations thereof are omitted. As used herein, the term “and/or” includes any and all combinations of one or more of the associated listed items.

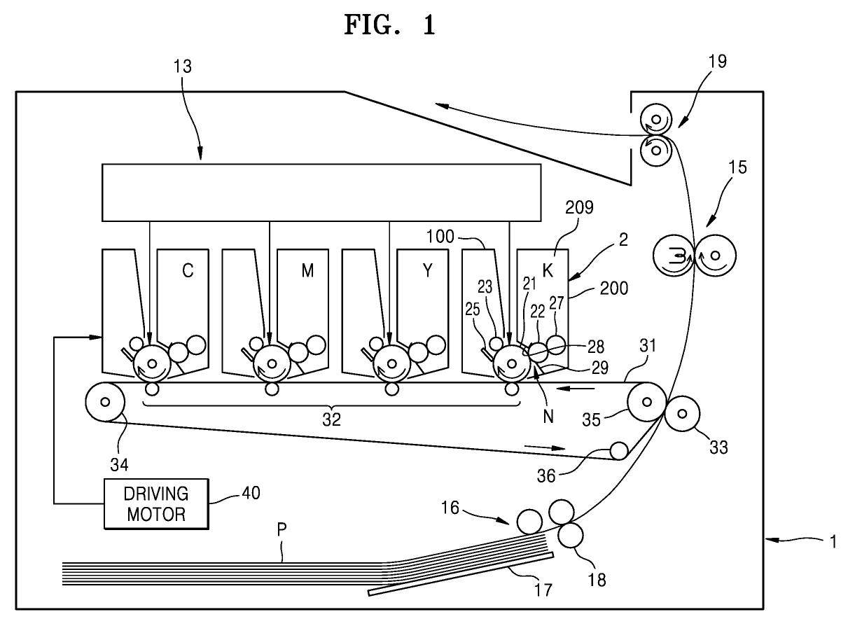

FIG. 1 is a schematic configuration diagram illustrating an electrophotographic image forming apparatus, according to an embodiment. The electrophotographic image forming apparatus (also referred to as the image forming apparatus) according to the present embodiment prints a color image to a recording medium P, according to an electrophotographic manner. Referring to FIG. 1, the image forming apparatus may include a main body 1 and a plurality of development cartridges 2. The plurality of development cartridges 2 are detachably attached to the main body 1. An exposure device 13, a transfer device, and a fixing device 15 are arranged at the main body 1. In addition, a recording medium transport unit for loading and transporting the recording medium P to which an image is to be formed is arranged at the main body 1.

For color printing, the plurality of development cartridges 2 may include four development cartridges 2 for developing images with cyan color, magenta color, yellow color, and black color. Developers, e.g., toners, with cyan (C) color, magenta (M) color, yellow (Y) color, and black (K) color may be contained in the four development cartridges 2, respectively. Although not illustrated, the toners with cyan color, magenta color, yellow color, and black color may be respectively contained in four toner supply containers, and may be respectively supplied from the four toner supply containers to the four development cartridges 2. The image forming apparatus may further include development cartridges 2 for containing and developing toners of other various colors such as a light magenta color, a white color, or the like. Hereinafter, the image forming apparatus including the four development cartridges 2 will now be described, and unless there is a particular description contrary thereto, items with reference numerals C, M, Y, and K indicate elements for developing images with cyan color, magenta color, yellow color, and black color.

In the present embodiment, each of the four development cartridges 2 is an integrated development cartridge. Each development cartridge 2 may include a photosensitive unit 100 and a developing unit 200.

The photosensitive unit 100 includes a photosensitive drum 21. The photosensitive drum 21, as a photosensitive body on which an electrostatic latent image is formed, may include a conductive metal pipe and a photosensitive layer formed at an outer circumference of the conductive metal pipe. A charging roller 23 is an example of a charger that charges a surface of the photosensitive drum 21 to have a uniform surface potential. Instead of the charging roller 23, a charging brush, a corona charger, or the like may be used. The photosensitive unit 100 may further include a cleaning roller (not shown) for removing foreign substances attached to a surface of the charging roller 23. A cleaning blade 25 is an example of a cleaning member that removes residual toners and foreign substances attached to the surface of the photosensitive drum 21 after a transfer process to be described below. Instead of the cleaning blade 25, a cleaning device in another form, such as a rotating brush, may be used.

The developing unit 200 includes a toner container 209. The developing unit 200 supplies a toner in the toner container 209 to an electrostatic latent image formed on the photosensitive drum 21, thereby developing the electrostatic latent image to a visible toner image. A developing method may include a one-component developing method using a toner and a two-component developing method using a toner and a carrier. In the present embodiment, the developing unit 200 adopts the one-component developing method. A developing roller 22 supplies a toner to the photosensitive drum 21. A developing bias voltage may be applied to the developing roller 22 to supply the toner to the photosensitive drum 21.

In the present embodiment, a contact development technique in which the developing roller 22 and the photosensitive drum 21 contact each other and thus form a development nip is used. A supply roller 27 supplies the toner in the toner container 209 to a surface of the developing roller 22. To do so, a supply bias voltage may be applied to the supply roller 27. The developing unit 200 may further include a regulation member 28 for regulating an amount of toner to be supplied to a development nip N where the photosensitive drum 21 and the developing roller 22 contact each other due to the developing roller 22. For example, the regulation member 28 may be a doctor blade that elastically contacts the surface of the developing roller 22. The developing unit 200 may further include a bottom sealing member 29 that contacts the developing roller 22 in an opposite side of the regulation member 28 so as to prevent a toner leakage. The bottom sealing member 29 may be a film that contacts the developing roller 22.

An exposure device 13 forms the electrostatic latent image on the photosensitive drum 21 by irradiating light to the photosensitive drum 21, the light being modulated according to image information. Examples of the exposure device 13 may include a laser scanning unit (LSU) using a laser diode as a light source, a light emitting diode (LED) exposure device using an LED as a light source, or the like.

A transfer device may include an intermediate transfer belt 31, a first transfer roller 32, and a second transfer roller 33. The intermediate transfer belt 31 temporarily receives a toner image developed on the photosensitive drum 21 of each of the development cartridges 2C, 2M, 2Y, and 2K. The intermediate transfer belt 31 is circularly driven while being supported by supporting rollers 34, 35, and 36. Four first transfer rollers 32 are positioned to face the photosensitive drums 21 of the development cartridges 2C, 2M, 2Y, and 2K by interposing the intermediate transfer belt 31 therebetween. A first transfer bias voltage is applied to the four first transfer rollers 32 so as to firstly transfer toner images, which are developed on the photosensitive drums 21, to the intermediate transfer belt 31. Instead of the first transfer rollers 32, a corona transfer device or a pin scorotron-type transfer device may be used. A second transfer roller 33 is positioned to face the intermediate transfer belt 31. A second transfer bias voltage is applied to the second transfer roller 33 so as to transfer, to the recording medium P, the toner images that are firstly-transferred to the intermediate transfer belt 31.

When a print command is transmitted from a host (not shown) or the like, a controller (not shown) charges, by using the charging roller 23, the surface of the photosensitive drum 21 to have a uniform surface potential.

The exposure device 13 forms electrostatic latent images on the photosensitive drums 21 by scanning four light-beams to the photosensitive drums 21 of the development cartridges 2C, 2M, 2Y, and 2K, the four light-beams being modulated according to image information corresponding to cyan, magenta, yellow, and black colors, respectively. The developing rollers 22 of the development cartridges 2C, 2M, 2Y, and 2K supply C, M, Y, and K toners to the photosensitive drums 21, respectively, thereby developing the electrostatic latent images to visible toner images. The developed toner images are firstly transferred to the intermediate transfer belt 31. The recording mediums P loaded on a loading plate 17 are output one by one by a pick-up roller 16, and are transported to a transfer nip by a feed roller 18, the transfer nip being formed by the second transfer roller 33 and the intermediate transfer belt 31. The toner images that are firstly-transferred to the intermediate transfer belt 31 are secondly transferred to the recording medium P due to the second transfer bias voltage applied to the second transfer roller 33. When the recording medium P passes through the fixing device 15, the toner images are fixed on the recording medium P due to heat and a pressure. The recording medium P for which fixing is completed is externally discharged by a discharging roller 19.

The development cartridges 2C, 2M, 2Y, and 2K may be detachably attached to the main body 1 through a door (not shown).

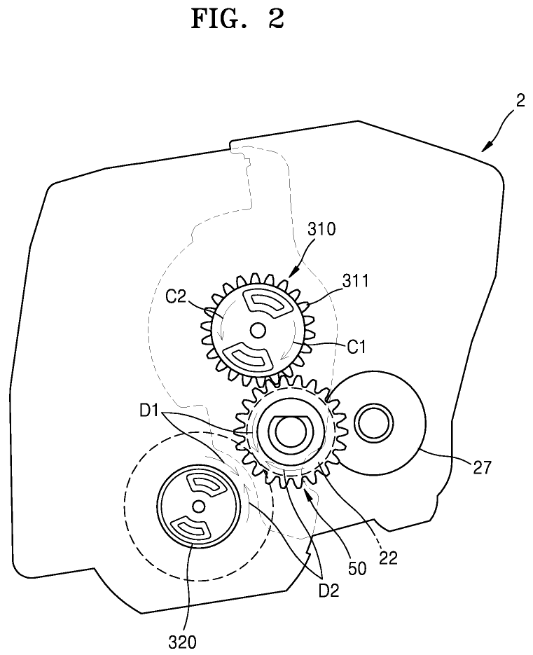

FIG. 2 is a side view of one of the development cartridges 2, according to an embodiment. Referring to FIG. 2, when the development cartridge 2 is mounted to the main body 1, rotational members of the development cartridge 2, e.g., the photosensitive drum 21 and the developing roller 22, may be driven by being connected to a driving motor 40 arranged at the main body 1. The driving motor 40 may be arranged at the main body 1 so as to drive the four development cartridges 2, or four driving motors 40 may be arranged with respect to the four development cartridges 2.

A coupler (a driving power receiving member) 310 may be arranged at the development cartridge 2 so as to be connected to the driving motor 40 at the main body 1 when the development cartridge 2 is mounted to the main body 1. The rotational members may be connected to the coupler 310 by using a power connecting member (not shown), e.g., gears. A coupler 320 may be further arranged at the development cartridge 2 so as to be connected to the driving motor 40 at the main body 1 when the development cartridge 2 is mounted to the main body 1. In this case, the developing roller 22 and the supply roller 27 may rotate by being coupled to the coupler 310, and the photosensitive drum 21 may rotate by being coupled to the coupler 320. The coupler 320 may be positioned on a same axis as a rotation axis of the photosensitive drum 21 or may be positioned on the rotation axis of the photosensitive drum 21.

During an image forming operation, the photosensitive drum 21 and the developing roller 22 rotate in a forward direction D1. When the driving motor 40 is forwardly driven, the coupler 310 rotates in a first direction C1, the developing roller 22 rotates in the forward direction D1, and the photosensitive drum 21 also rotates in the forward direction D1 by using the coupler 320. If required, the photosensitive drum 21 may rotate in a reverse direction D2. For example, when a reusable paper is often used as the recording medium P, paper dusts from the reusable paper are attached onto the photosensitive drum 21 and the cleaning blade 25 so that a printing error with a shape of a line in a longitudinal direction (a rotation direction of the photosensitive drum 21) may occur on a printed image. In order to remove the paper dusts, the driving motor 40 may be reversely driven to allow the photosensitive drum 21 to rotate in the reverse direction D2. In this regard, when the coupler 310 rotates in a second direction C2, the developing roller 22 may also rotate in the reverse direction D2. As described above, when the developing roller 22 rotates in the reverse direction D2, a toner is leaked between the bottom sealing member 29 and the developing roller 22 that have a relatively low contact pressure. The leaked toner is transported to an area of the regulation member 28 due to rotation of the developing roller 22, and since a contact pressure of the regulation member 28 with respect to the developing roller 22 is higher than the contact pressure of the bottom sealing member 29 with respect to the developing roller 22, the toner does not pass through a gap between the regulation member 28 and the developing roller 22. Therefore, the toner may be collected in the vicinity of the regulation member 28 and then may fall to the inside of the image forming apparatus, thereby contaminating the image forming apparatus. When the developing roller 22 rotates again in the forward direction D1, the toner collected in the vicinity of the regulation member 28 may leave the developing roller 22 and thus may contaminate the image forming apparatus.

A side sealing member (not shown) is disposed between longitudinal-direction ends of the developing roller 22 and ends of the toner container 209. When the developing roller 22 repeatedly rotates in the forward direction D1 and the reverse direction D2, the developing roller 22 may repeatedly move in a longitudinal direction due to thrust and then may repeatedly interfere with the side sealing member, so that a sealing function of the side sealing member may deteriorate, resulting a toner leakage to the outside of the toner container 209 and damage to the developing roller 22. In addition, when the developing roller 22 rotates in the reverse direction D2, the regulation member 28 installed in a counter manner may be deformed so that its regulation function may deteriorate or the regulation member 28 may be damaged.

In order to solve these problems, torque of the driving motor 40 may not be delivered to the developing roller 22 when the driving motor 40 is reversely driven. Referring to FIG. 2, the development cartridge 2 includes a power delivery member 50. The power delivery member 50 connects the coupler 310 to the developing roller 22, and delivers only torque of the coupler 310 in the first direction C1 to the developing roller 22.

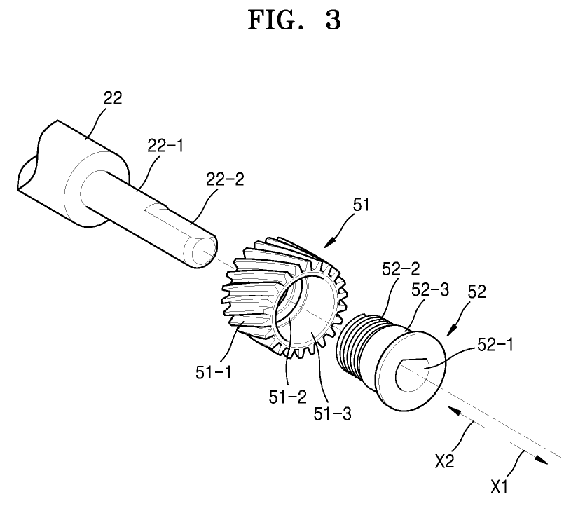

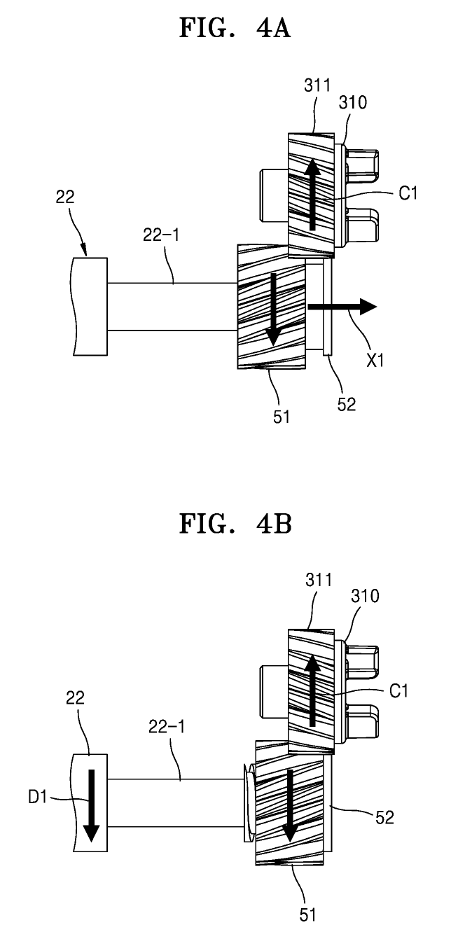

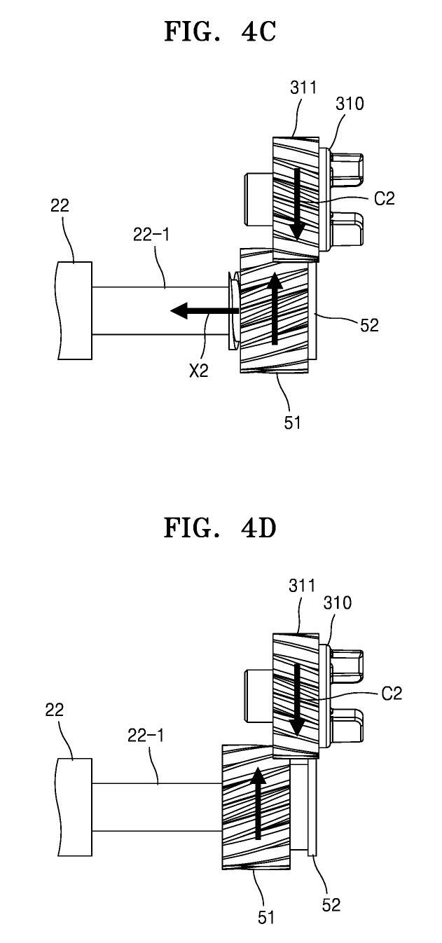

FIG. 3 is an exploded perspective view of the power delivery member 50, according to an embodiment. Referring to FIGS. 2 and 3, the power delivery member 50 includes a rotational member 51 and a delivery member 52. The rotational member 51 is coupled to the coupler 310 and rotates. The coupler 310 includes a first gear 311 (refer to FIG. 4A), and the rotational member 51 includes a second gear 51-1 coupled to the first gear 311. When the coupler 310 rotates in the first direction C1 and the second direction C2, the rotational member 51 may reciprocate in axial directions X1 and X2. The delivery member 52 selectively delivers torque of the rotational member 51 to the developing roller 22 according to a rotation direction of the coupler 310. To do so, the rotational member 51 includes a first latch, and the delivery member 52 includes a second latch. The first and second latches have forms that are complementary with each other so as to deliver the torque of the rotational member 51 to the delivery member 52 only when the coupler 310 rotates in the first direction C1, and not to deliver the torque of the rotational member 51 to the delivery member 52 when the coupler 310 rotates in the second direction C2. When the coupler 310 rotates in the first direction C1, the rotational member 51 is moved to a first position where the first and second latches are connected to each other, and when the coupler 310 rotates in the second direction C2, the rotational member 51 is moved to a second position where the first and second latches are disconnected from each other.

Referring to FIG. 3, the delivery member 52 is combined with a rotation axis 22-1 of the developing roller 22. For example, a D-cut portion 22-2 is arranged at an end of the rotation axis 22-1, and an insertion hole 52-2 having a complementary shape with the D-cut portion 22-2 is arranged at the delivery member 52. The delivery member 52 has a male screw 52-2 and a cylindrical-shape first support part 52-3 on its outer circumferential surface. The rotational member 51 has a female screw 51-2 and a cylindrical-shape second support part 51-3 to be rotatably supported by the cylindrical-shape first support part 52-3. A diameter of the female screw 51-2 is greater than an external diameter of the rotation axis 22-1. When the rotational member 51 is mounted on the rotation axis 22-1, and the delivery member 52 is combined with the rotation axis 22-1, the first support part 52-3 is inserted into the second support part 51-3. The female screw 51-2 and the male screw 52-2 are respective examples of the first latch and the second latch. When the coupler 310 rotates in the first direction C1, the female screw 51-2 and the male screw 52-2 are coupled to each other, and when the coupler 310 rotates in the second direction C2, the female screw 51-2 and the male screw 52-2 are decoupled from each other.

FIGS. 4A through 4D illustrate operations of the power delivery member 50 shown in FIG. 3. Referring to FIG. 4A, the rotational member 51 is positioned at a second position. In this state, when the coupler 310 rotates in the first direction C1, the female screw 51-2 and the male screw 52-2 are coupled to each other and the rotational member 51 is moved in the axial direction X1. While the rotational member 51 is moved in the axial direction X1, the delivery member 52 and the developing roller 22 do not rotate.

As illustrated in FIG. 4B, when the rotational member 51 reaches a first position, the female screw 51-2 and the male screw 52-2 are completely coupled to each other. In this state, when the coupler 310 rotates in the first direction C1, the torque of the rotational member 51 is delivered to the developing roller 22 via the delivery member 52, and the developing roller 22 rotates in the forward direction D1.

In the state shown in FIG. 4B, when the coupler 310 rotates in the second direction C2, the female screw 51-2 is decoupled from the male screw 52-2 as shown in FIG. 4C, and the rotational member 51 is moved in the axial direction X2 and the delivery member 52 does not rotate. Therefore, the developing roller 22 does not rotate, either.

As shown in FIG. 4D, when the rotational member 51 reaches the second position, the rotational member 51 rotates while the second support part 51-3 of the rotational member 51 is supported by the first support part 52-3 of the delivery member 52. In this state, even if the coupler 310 keeps rotating in the second direction C2, the rotational member 51 rotates while being supported by the delivery member 52 so that the delivery member 52 and the developing roller 22 do not rotate.

According to the aforementioned structure, the developing roller 22 does not rotate while the photosensitive drum 21 rotates in the reverse direction D2, so that durability of the developing roller 22 may be maintained, and contamination of the image forming apparatus due to the toner leakage may be prevented.

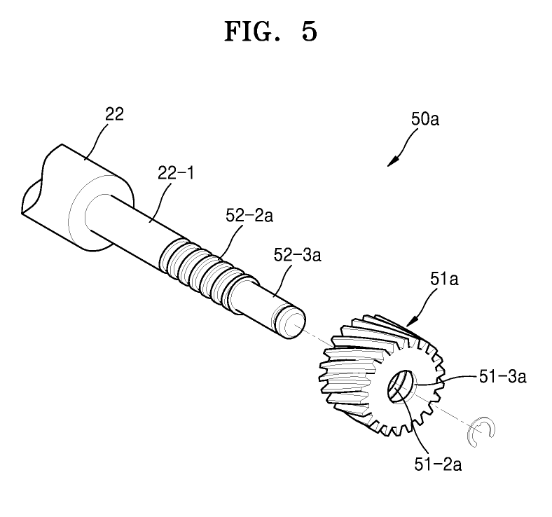

FIG. 5 is an exploded perspective view of a power delivery member 50a, according to another embodiment. Referring to FIG. 5, the power delivery member 50a according to the present embodiment is different from the embodiment of FIG. 3 in that the male screw 52-2 is directly arranged on the rotation axis 22-1 of the developing roller 22. That is, the rotation axis 22-1 of the developing roller 22 functions as the delivery member 52. A male screw 52-2a is formed at a side of the rotation axis 22-1, and a first support part 52-3a is arranged at an outer side of the male screw 52-2a. A diameter of the first support part 52-3a is smaller than a root diameter of the male screw 52-2a. A rotational member 51a includes a female screw 51-2a, and a second support part 51-3a to be rotatably supported by the first support part 52-3a.

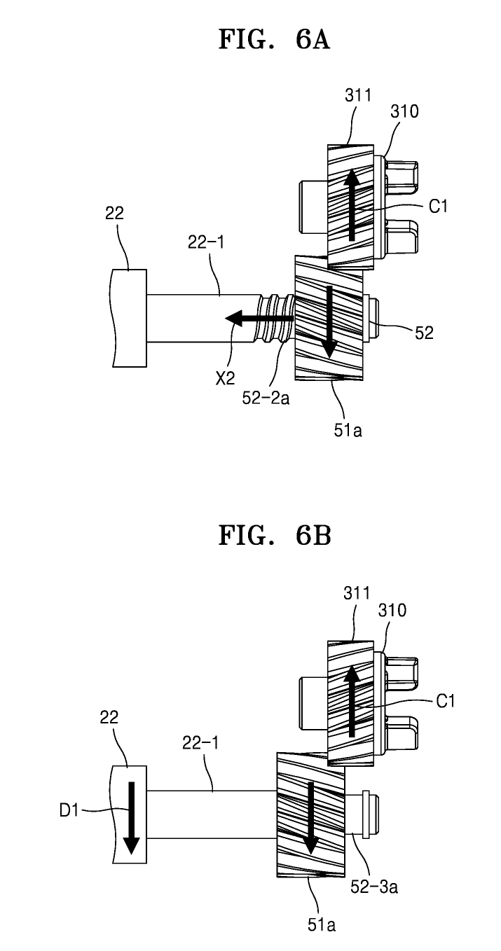

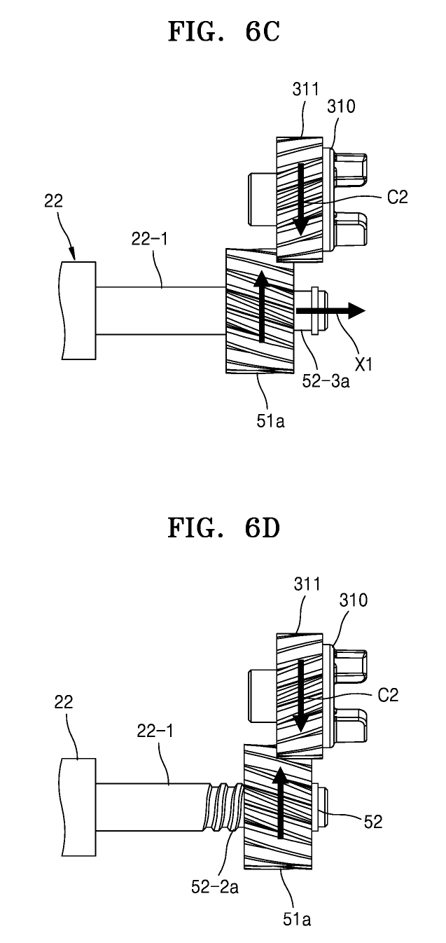

FIGS. 6A through 6D illustrate operations of the power delivery member 50a shown in FIG. 5. Referring to FIG. 6A, the rotational member 51a is positioned at the second position. In this state, when the coupler 310 rotates in the first direction C1, the female screw 51-2a and the male screw 52-2a are coupled to each other, and the rotational member 51a is moved in the axial direction X2. While the rotational member 51a is moved in the axial direction X2, the developing roller 22 does not rotate.

As illustrated in FIG. 6B, when the rotational member 51a reaches the first position, the female screw 51-2a and the male screw 52-2a are completely coupled to each other. In this state, when the coupler 310 rotates in the first direction C1, torque of the rotational member 51a is delivered to the rotation axis 22-1 of the developing roller 22, and the developing roller 22 rotates in the forward direction D1.

In the state shown in FIG. 6B, when the coupler 310 rotates in the second direction C2, the female screw 51-2a is decoupled from the male screw 52-2a as shown in FIG. 6C, and the rotational member 51a is moved in the axial direction X1, and the developing roller 22 does not rotate.

As shown in FIG. 6D, when the rotational member 51a reaches the second position, the rotational member 51a rotates while the second support part 51-3a thereof is supported by the first support part 52-3a. In this state, even if the coupler 310 keeps rotating in the second direction C2, the rotational member 51a rotates while being supported by the first support part 52-3a so that the developing roller 22 does not rotate.

In the embodiments of FIGS. 3 through 5, the first gear 311 and the second gear 51-1 may be helical gears. In this case, helical directions of the first gear 311 and the second gear 51-1 may be determined to generate thrust in a direction toward where the rotational members 51 and 51a are moved to the first position, i.e., in a direction where the female screws 51-2 and 51-2a are coupled to the male screws 52-2 and 52-2a when the coupler 310 rotates in the first direction C1. By doing so, the rotational members 51 and 51a may be easily moved from the second position to the first position. In addition, even when the female screws 51-2 and 51-2a are spaced apart from the male screws 52-2 and 52-2a, the female screws 51-2 and 51-2a and the male screws 52-2 and 52-2a may be easily coupled to each other when the coupler 310 rotates in the first direction C1. On the other hand, when the coupler 310 rotates in the second direction C2, due to the thrust of the first gear 311 and the second gear 51-1 that are the helical gears, a thrust to move the rotational members 51 and 51a toward the second position is applied to the rotational members 51 and 51a, so that the female screws 51-2 and 51-2a may be easily decoupled from the male screws 52-2 and 52-2a.

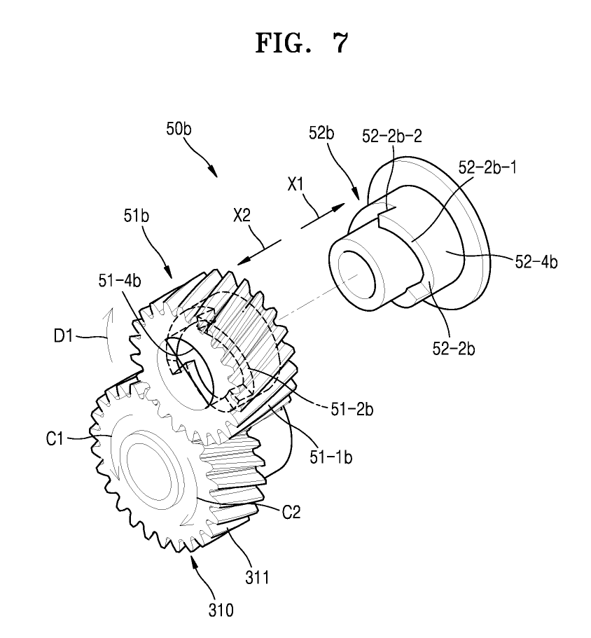

FIG. 7 is an exploded perspective view of a power delivery member 50b, according to another embodiment. FIG. 7 illustrates only a portion of the coupler 310 to rotate the developing roller 22. Referring to FIG. 7, the power delivery member 50b includes a rotational member 51b and a delivery member 52b, wherein the rotational member 51b is coupled to the coupler 310 and rotates, and the delivery member 52b is combined with the rotation axis 22-1 of the developing roller 22. The combined structure of the delivery member 52b and the rotation axis 22-1 may be the same as the combined structure of the delivery member 52 and the rotation axis 22-1 shown in FIG. 3.

The coupler 310 includes the first gear 311 in the form of a helical gear. The rotational member 51b includes a second gear 51-1b in the form of a helical gear to be engaged with the first gear 311. Helical directions of the first and second gears 311 and 51-1b are determined to generate thrust in a direction toward where the delivery member 52b is moved to the first position, i.e., in the axial direction X1, when the coupler 310 rotates in the first direction C1, and in a direction in which the delivery member 52b is moved to the second position, i.e., in the axial direction X2, when the coupler 310 rotates in the second direction C2. Due to this configuration, the rotational member 51b may rotate about a common axis with the delivery member 52b, and may be moved in the axial directions X1 and X2.

In the present embodiment, first and second latches 51-2b and 52-2b of the power delivery member 50b have concavo-convex shapes that are complementary in the axial directions X1 and X2, so that the first and second latches 51-2b and 52-2b are engaged with each other when the rotational member 51b is positioned at the first position, and the first and second latches 51-2b and 52-2b are spaced apart from each other when the rotational member 51b is positioned at the second position. The first latch 51-2b is arranged at the rotational member 51b, and the second latch 52-2b is arranged at the delivery member 52b. The first and second latches 51-2b and 52-2b may deliver only torque in one direction. That is, the first and second latches 51-2b and 52-2b may have shapes that are engaged with each other to deliver torque to each other when they rotate in one direction, and that are spaced apart from each other when they rotate in another direction. For example, as illustrated in FIG. 7, the second latch 52-2b may have a slope 52-2b-1 and a facing surface 52-2b-2, wherein the slope 52-2b-1 extends in a circular direction and is slanted in an axial direction and the facing surface 52-2b-2 extends in the axial direction from the slope 52-2b-1. The first latch 51-2b and the second latch 52-2b may have shapes that are complementary with each other. The rotational member 51b may have an inner diameter portion 51-4b, and the first latch 51-2b may be formed at an inner wall of the inner diameter portion 51-4b. The delivery member 52b may have an outer diameter portion 52-4b, and the second latch 52-2b may be formed at an outer surface of the outer diameter portion 52-4b. The second latch 52-2b is inserted into the inner diameter portion 51-4b. By doing so, while the first latch 51-2b and the second latch 52-2b are engaged with each other, torque of the rotational member 51b may be delivered to the delivery member 52b, and when the first latch 51-2b and the second latch 52-2b are spaced apart from each other, the torque of the rotational member 51b is not delivered to the delivery member 52b.

When the coupler 310 rotates in the first direction C1, the rotational member 51b is moved in the axial direction X1 and thus reaches the first position, and the first and second latches 51-2b and 52-2b are engaged with each other. Torque of the coupler 310 in the first direction C1 is delivered to the developing roller 22 via the delivery member 52b. Therefore, the developing roller 22 rotates in the forward direction D1.

When the coupler 310 rotates in the second direction C2, thrust in the axial direction X2 that is opposite to the axial direction X1 is generated in the rotational member 51b. Therefore, the rotational member 51b is moved in the axial direction X2 and thus reaches the second position, and the first and second latches 51-2b and 52-2b are spaced apart from each other. In a rotation direction of the rotational member 51b when the coupler 310 rotates in the second direction C2, the first and second latches 51-2b and 52-2b are pushed away from each other, thus, the rotational member 51b is easily moved in the axial direction X2. Therefore, torque of the coupler 310 in the second direction C2 is not delivered to the delivery member 52b and the developing roller 22, and the developing roller 22 does not rotate.

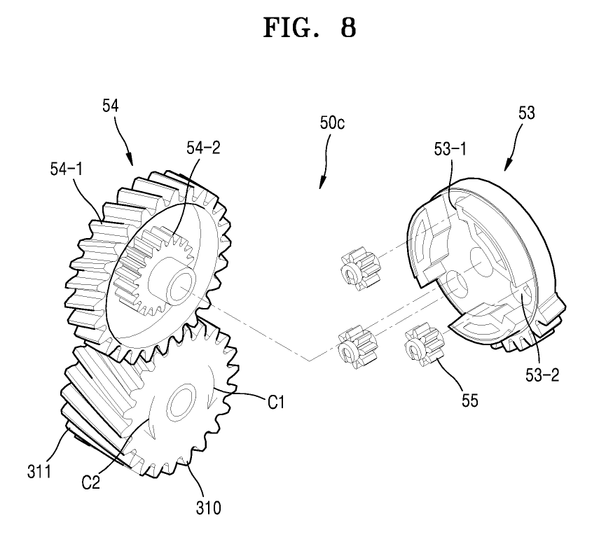

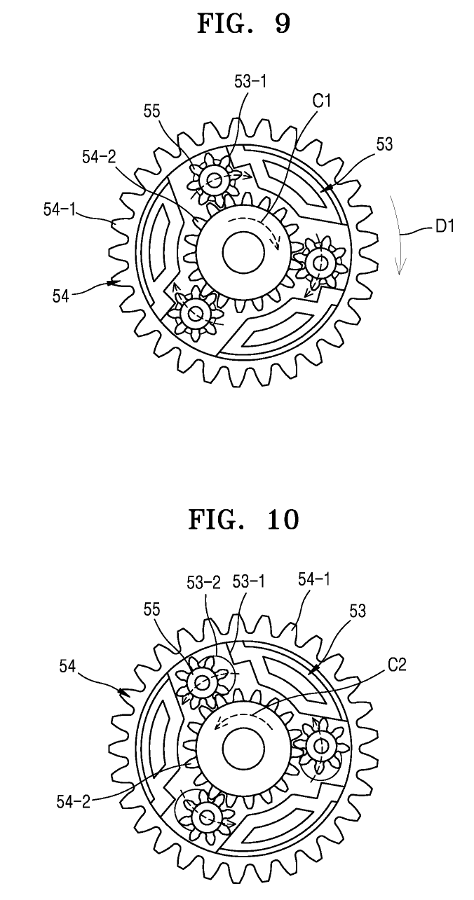

FIG. 8 is an exploded perspective view of a power delivery member 50c, according to another embodiment. FIG. 9 illustrates the coupler 310 that rotates in the first direction C1 in the embodiment of the power delivery member 50c of FIG. 8. FIG. 10 illustrates the coupler 310 that rotates in the second direction C2 in the embodiment of the power delivery member 50c of FIG. 8. In FIGS. 8 through 10, only a portion of the coupler 310 to rotate the developing roller 22 is illustrated.

Referring to FIG. 8, the power delivery member 50c includes a first rotational member 53, a second rotational member 54, and a latch gear 55. The first rotational member 53 is combined with the rotation axis 22-1 of the developing roller 22. The combined structure of the first rotational member 53 and the rotation axis 22-1 may be the same as the combined structure of the delivery member 52 and the rotation axis 22-1 shown in FIG. 3. The first rotational member 53 includes a latch 53-1 and a guiding portion 53-2. The guiding portion 53-2 is provided to enable a swing and rotation of the latch gear 55. The second rotational member 54 is coupled to the coupler 310 and rotates. The second rotational member 54 includes a second gear 54-1 to be engaged with the first gear 311 of the coupler 310, and an inner gear 54-2. The inner gear 54-2 is engaged with the latch gear 55. According to rotation directions of the second rotational member 54, the latch gear 55 moves (swings) to an engaged position (refer to FIG. 9) so as to be engaged with the latch 53-1, and to a disengaged position (refer to FIG. 10) spaced apart from the latch 53-1.

When the coupler 310 rotates in the first direction C1, the latch gear 55 swings along the guiding portion 53-2 in a rotation direction of the second rotational member 54 as shown in FIG. 9, and is engaged with the latch 53-1. In this state, the latch 53-1 does not rotate, and the first rotational member 53 rotates along with the second rotational member 54. Therefore, the developing roller 22 rotates in the forward direction D1.

When the coupler 310 rotates in the second direction C2, the latch gear 55 swings along the guiding portion 53-2 in a rotation direction of the second rotational member 54 as shown in FIG. 10 and is spaced apart from the latch 53-1. The latch gear 55 rotates in the guiding portion 53-2. Therefore, torque of the coupler 310 in the second direction C2 is not delivered to the first rotational member 53, and the developing roller 22 does not rotate.

In the embodiments of FIGS. 2 through 7, the rotational members 51, 51a, 51b, and 54 may be combined with the coupler 310 via a direct gear coupling structure, or a plurality of gears may be arranged between the rotational members 51, 51a, 51b, and 54 and the coupler 310.

During an image forming operation, the photosensitive drum 21 and the developing roller 22 contact each other to form the development nip N. However, if the photosensitive drum 21 and the developing roller 22 maintain their contact even if the image forming operation is not performed, the developing roller 22 may be deformed, and the photosensitive body may be damaged. In addition, when a plurality of images are continuously printed, if the photosensitive drum 21 and the developing roller 22 maintain their contact during an image non-forming period between image forming periods, a toner on the developing roller 22 is delivered to the photosensitive drum 21 during the image non-forming period so that an amount of toner consumption may be increased and waste toner may be increased, and since the photosensitive drum 21 and the developing roller 22 rotate while contacting each other, a stress is applied to the developing roller 22 so that a life of the developing roller 22 may be decreased.

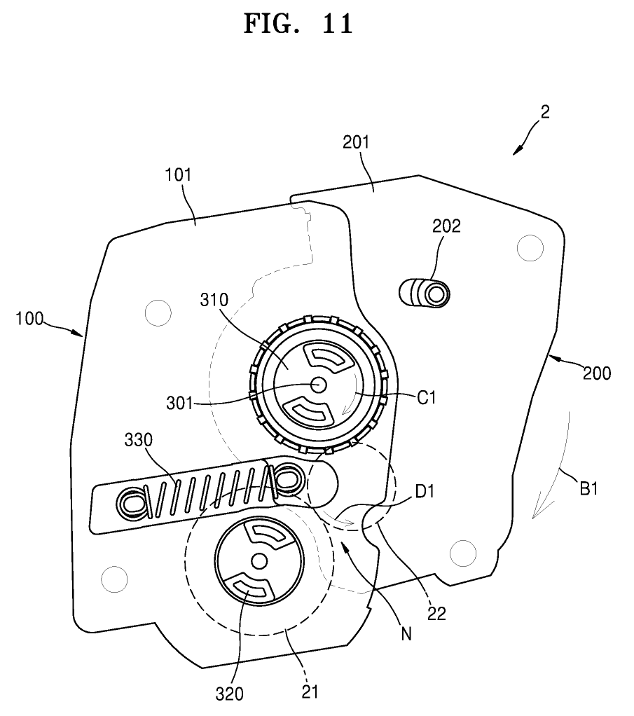

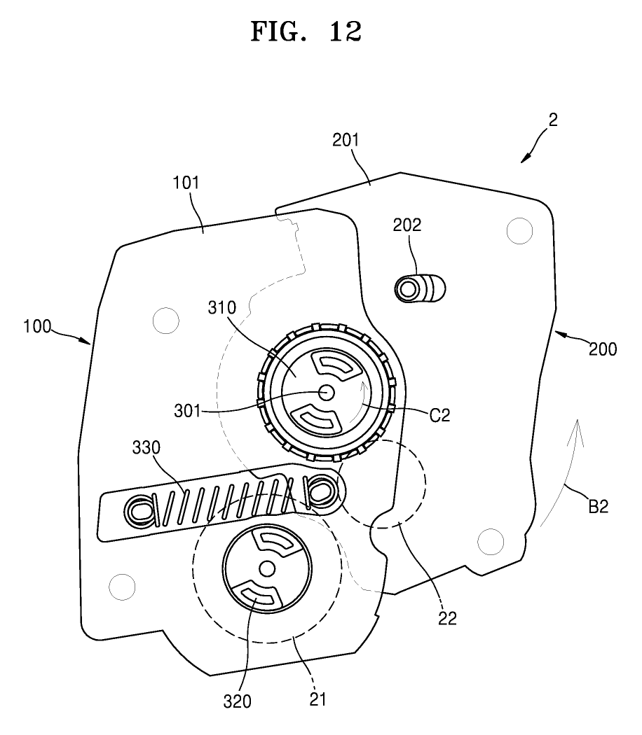

FIGS. 11 and 12 are side views of the development cartridge 2, according to an embodiment. FIG. 11 illustrates a state in which the photosensitive drum 21 and the developing roller 22 contact each other so that the development nip N is formed, and FIG. 12 illustrates a state in which the photosensitive drum 21 and the developing roller 22 are spaced apart from each other so that the development nip N is released.

Referring to FIGS. 11 and 12, the development cartridge 2 includes the photosensitive unit 100 and the developing unit 200. The photosensitive unit 100 may include a first frame 101 and the photosensitive drum 21 supported by the first frame 101. The developing unit 200 may include a second frame 201 and the developing roller 22 supported by the second frame 201. The photosensitive unit 100 and the developing unit 200 are connected to each other so as to rotate to a development position (refer to FIG. 11) where the photosensitive drum 21 and the developing roller 22 contact each other to form the development nip N and a release position (refer to FIG. 12) where the photosensitive drum 21 and the developing roller 22 are spaced apart from each other to release the development nip N. For example, the photosensitive unit 100 and the developing unit 200 are connected to rotate to the development position and the release position with respect to a hinge axis 301. In the image forming apparatus, the photosensitive drum 21 is related to a location of the first transfer roller 32, or the like, thus, when the development cartridge 2 is mounted to the main body 1, a position of the photosensitive drum 21 is fixed. The developing unit 200 is coupled to the photosensitive unit 100 so as to be rotatable with respect to the hinge axis 301.

Rotational members of the development cartridge 2, e.g., the photosensitive drum 21, the developing roller 22, the supply roller 27, or the like may be driven by being connected to the driving motor 40 when the development cartridge 2 is mounted to the main body 1. The driving motor 40 may drive all of the four development cartridges 2, or four driving motors 40 may be arranged with respect to the four development cartridges 2.

For example, the coupler (the driving power receiving member) 310 may be arranged at the development cartridge 2 so as to be connected to the driving motor 40 at the main body 1 when the development cartridge 2 is mounted to the main body 1. The rotational members may be connected to the coupler 310 by using the power connecting member (not shown), e.g., the gears. The coupler 320 may be further arranged at the development cartridge 2 so as to be connected to the driving motor 40 at the main body 1 when the development cartridge 2 is mounted to the main body 1. In this case, the rotational members of the developing unit 200, e.g., the developing roller 22 and the supply roller 27, may rotate by being coupled to the coupler 310, and the rotational member of the photosensitive unit 100, e.g., the photosensitive drum 21, may rotate by being coupled to the coupler 320. The coupler 320 may be positioned on a same axis as a rotation axis of the photosensitive drum 21 or may be positioned on the rotation axis of the photosensitive drum 21. The hinge axis 301 may be a same axis as the rotation axis of the coupler 310.

An elastic member 330 provides an elastic force to generate the development nip N. The elastic member 330 provides the elastic force to the developing unit 200 to rotate in a direction where the development nip N is to be formed. Due to the elastic force of the elastic member 330, the developing unit 200 rotates with respect to the hinge axis 301, so that the developing roller 22 contacts the photosensitive drum 21 and thus the development nip N is formed as shown in FIG. 11. FIGS. 11 and 12 illustrate, as an example of the elastic member 330, a tension coil spring of which ends are supported by the developing unit 200 and the photosensitive unit 100, respectively, but the example of the elastic member 330 is not limited thereto. For example, a member having one of various types including a torsion coil spring, a plate spring, or the like may be used as the elastic member 330.

The development cartridge 2 of the present embodiment may include a development nip releasing member to move the developing unit 200 to the development position where the development nip N is formed and to the release position where the development nip N is released. The development nip releasing member locates the developing unit 200 at the development position during a printing operation (an image forming operation and an image forming period), and locates the developing unit 200 at the release position during a non-printing operation (while the image forming operation is not performed, and an image non-forming period). The development nip releasing member shifts the developing unit 200 between the development position and the release position, according to a rotation direction of the coupler 310. For example, when the coupler 310 rotates in the first direction C1, the developing roller 22 rotates in the forward direction D1. When the coupler 310 rotates in the second direction C2, the development nip releasing member shifts the developing unit 200 from the development position to the release position. When the coupler 310 rotates in the first direction C1 again, the development nip releasing member shifts the developing unit 200 from the release position to the development position.

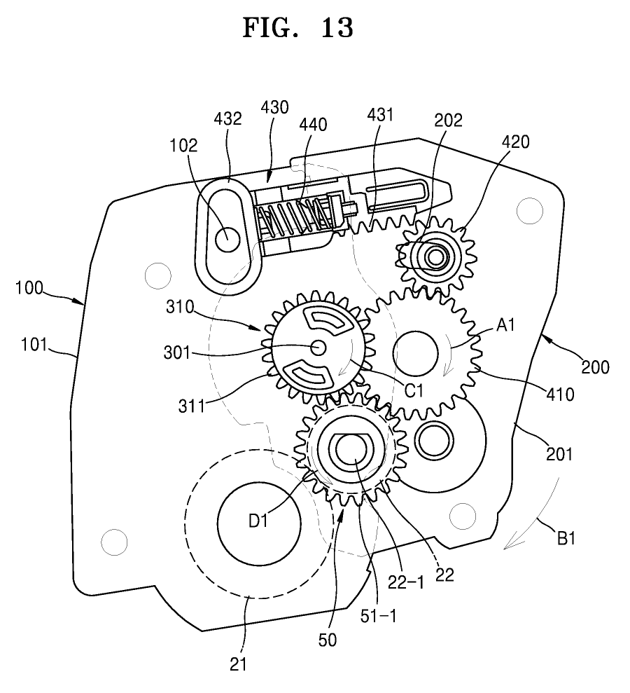

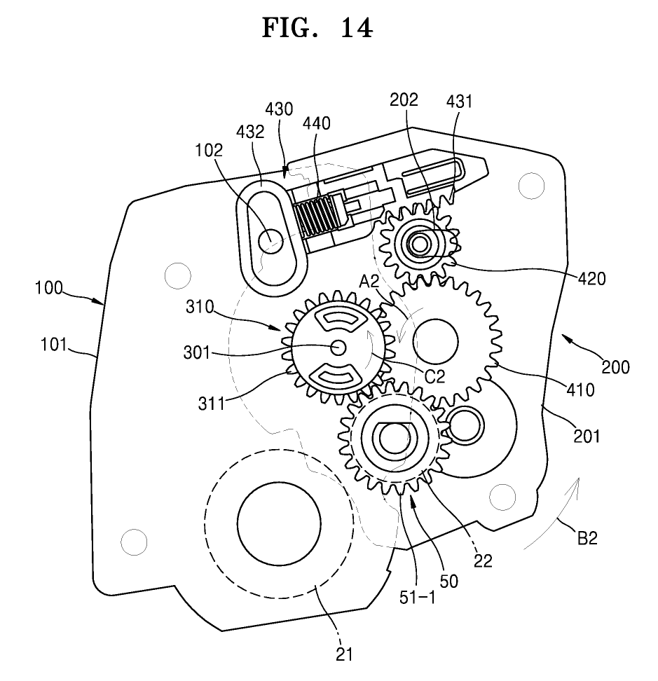

FIGS. 13 and 14 are side views of the development cartridge 2, according to an embodiment. FIG. 13 illustrates a state in which the developing unit 200 is positioned at the development position, and FIG. 14 illustrates a state in which the developing unit 200 is positioned at the release position. Referring to FIGS. 13 and 14, the development cartridge 2 may include a driving gear 410. The driving gear 410 may rotate by being coupled to the coupler 310. In the present embodiment, the coupler 310 includes the first gear 311, and in this regard, the first gear 311 is engaged with the second gear 51-1 in the power delivery member 50. Instead of the power delivery member 50, the power delivery members 50a, 50b, and 50c respectively shown in FIGS. 5, 7, and 8 may be used. The driving gear 410 is engaged with the second gear 51-1. When the coupler 310 rotates in the first direction C1 and the second direction C2, the driving gear 410 rotates in a direction A1 and a direction A2. The coupler 310 rotates in the first direction C1 during a printing operation, and rotates in the second direction C2 during a non-printing operation.

A moving member 430 is included in the developing unit 200. The moving member 430 shifts the developing unit 200 between the development position and the release position by rotating the developing unit 200 with respect to the hinge axis 301. To do so, the moving member 430 is mounted in the developing unit 200, e.g., the second frame 201, so as to be movable to a third position and a fourth position corresponding to the release position and the development position, respectively. The moving member 430 includes a gear 431. In the present embodiment, the moving member 430 slides to the third and fourth positions and the gear 431 is a rack gear. The moving member 430 is moved to the third and fourth positions, according to a rotation direction of the driving gear 410. For example, the driving gear 410 rotates in the direction A2 during a non-printing operation, and rotates in the direction A1 during a printing operation. Hereinafter, the rotation direction of the driving gear 410 is marked, A2 indicates a rotation direction during a non-printing operation, and A1 indicates a rotation direction during a printing operation.

The moving member 430 includes a second connection part 432 to be connected to a first connection part 102 placed at the first frame 101. For example, the first connection part 102 may have a projected shape, and the second connection part 432 may have a loop shape to which the first connection part 102 is inserted. Shapes of the first and second connection parts 102 and 432 are not limited to those shown in FIG. 13.

A switching member is interposed between the moving member 430 and the driving gear 410. The switching member rotates by being coupled to the driving gear 410. The switching member is switched between a first switching position and a second switching position when the driving gear 410 rotates in the directions A1 and A2, wherein, at the first switching position, the switching member is spaced apart from the gear 431 and allows the moving member 430 to switch from the third position to the fourth position, and at the second switching position, the switching member is coupled to the gear 431 and allows the moving member 430 to switch from the fourth position to the third position.

In the present embodiment, a swing gear 420 is used as the switching member. The swing gear 420 is engaged with the driving gear 410 and swings between the first switching position (FIG. 13) and the second switching position (FIG. 14), according to rotation directions of the driving gear 410. When the driving gear 410 rotates in the direction A2, as illustrated in FIG. 14, the swing gear 420 is positioned at the second switching position and is engaged with the gear 431. When the driving gear 410 rotates in the direction A1, as illustrated in FIG. 13, the swing gear 420 is positioned at the first switching position, and is spaced apart from the gear 431. A guiding portion 202 may be arranged in the developing unit 200, e.g., the second frame 201, so as to allow the swing gear 420 to swing between the first switching position and the second switching position. The guiding portion 202 may have a long-hole shape.

A spring 440 provides the moving member 430 with an elastic force to maintain the moving member 430 at the fourth position.

With reference to FIGS. 13 and 14, a process of forming and releasing the development nip N will now be described.

Referring to FIG. 13, the developing unit 200 is positioned at the development position, the moving member 430 is positioned at the fourth position, and the swing gear 420 is positioned at the second switching position. For printing, the driving motor 40 arranged at the main body 1 rotates in a forward direction, and the coupler 310 rotates in the first direction C1. In this regard, torque of the coupler 310 in the first direction C1 is delivered to the developing roller 22 by the power delivery member 50, and the developing roller 22 rotates in the forward direction D1. The driving gear 410 rotates in the direction A1 by being coupled to the second gear 51-1. Then, as illustrated in FIG. 13, the swing gear 420 is positioned at the second switching position, and remains spaced apart from the gear 431. Therefore, the moving member 430 remains at the fourth position, and the developing roller 22 rotates in the forward direction D1 by being coupled to the coupler 310 via the power delivery member 50. Therefore, a printing operation may be performed while the development nip N is formed.

During a non-printing operation, when the driving motor 40 rotates in a reverse direction, the coupler 310 rotates in the second direction C2. In this regard, due to the power delivery member 50, torque of the coupler 310 in the second direction C2 is not delivered to the developing roller 22, so that the developing roller 22 does not rotate. The driving gear 410 coupled to the second gear 51-1 rotates in the direction A2. Then, as illustrated in FIG. 14, the swing gear 420 swings to the first switching position and is engaged with the gear 431. When the driving gear 410 continuously rotates in the direction A2, the swing gear 420 rotates while being engaged with the gear 431. The moving member 430 slides from the fourth position to the third position, and the second connection part 432 pulls the first connection part 102. Since a position of the photosensitive unit 100 is fixed, the developing unit 200 rotates in an arrow direction B2 with respect to the hinge axis 301. As illustrated in FIGS. 12 and 14, when the moving member 430 reaches the third position, the developing unit 200 reaches the release position, and the developing roller 22 is spaced apart from the photosensitive drum 21, so that the development nip N is released.

When the driving motor 40 is stopped, the developing unit 200 may remain at the release position. Due to the elastic force of the elastic member 330, the developing unit 200 tends to return to the development position. However, since the driving motor 40, the coupler 310, the driving gear 410, the swing gear 420, and the gear 431 are coupled to each other, the developing unit 200 may remain at the release position.

When the driving motor 40 rotates in a forward direction for printing, in a state shown in FIG. 14, torque of the driving motor 40 is delivered to the driving gear 410 via the coupler 310, so that the driving motor 40 rotates in the direction A1. In this regard, since torque of the coupler 310 in the first direction C1 is delivered to the developing roller 22, the developing roller 22 rotates in the forward direction D1. As illustrated in FIG. 13, the swing gear 420 swings to the second switching position, and due to the elastic force of the elastic member 330 of the developing unit 200, the developing unit 200 rotates in an arrow direction B1. Since the first connection part 102 and the second connection part 432 are connected to each other, the moving member 430 slides from the third position to the fourth position. When the moving member 430 reaches the fourth position, the swing gear 420 remains at the second switching position, the moving member 430 remains at the fourth position, and a printing operation may be performed while the development nip N is formed.

According to the embodiments of the development cartridge 2, the development nip N may be formed or released by rotating the driving gear 410 by rotating the coupler 310 in the first direction C1 or the second direction C2, so that a device structure for forming and releasing the development nip N in the main body 1 is not necessary, therefore, the number of parts of the main body 1 may be decreased and the manufacturing costs and a size of the image forming apparatus may be reduced due to the decrease. In addition, the development nip N may be separated by a structure provided in the development cartridge 2, so that a particular separating member for maintaining a separation state of the development nip N may not be mounted to the development cartridge 2. Accordingly, it is possible to resolve inconvenience of a user who has to remove a separating member when initially mounting the development cartridge 2 to the main body 1. In addition, since the power delivery member 50 is used, when the coupler 310 rotates in the second direction C2, the developing roller 22 does not rotate due to the power delivery member 50. Therefore, damage to parts or a leakage of a toner due to rotation of the developing roller 22 in the reverse direction D2 may be prevented.

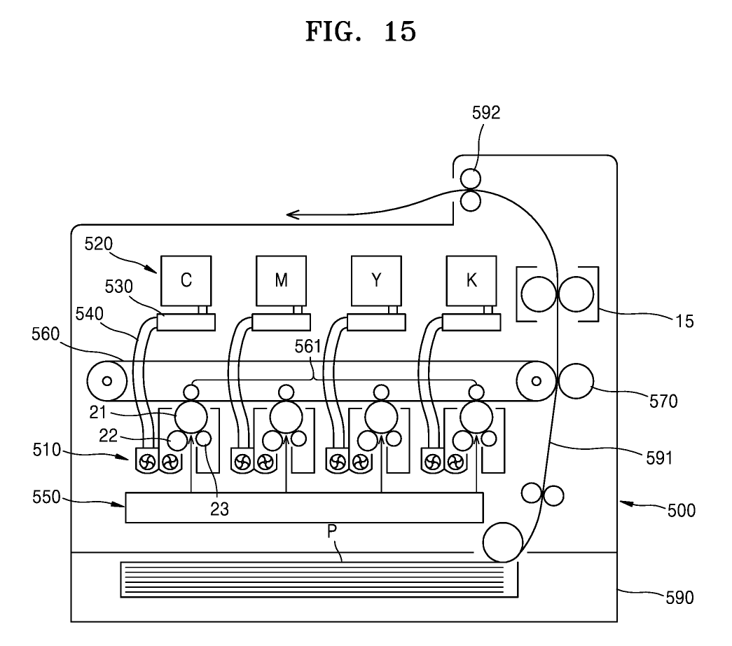

FIG. 15 is a schematic configuration diagram illustrating an electrophotographic image forming apparatus, according to another embodiment. Referring to FIG. 15, the electrophotographic image forming apparatus (also referred to as the image forming apparatus) according to the present embodiment prints a color image medium in an electrophotographic manner. The image forming apparatus includes a plurality of development cartridges 510 and a plurality of developer cartridges 520 accommodating developers. The developer cartridges 520 are respectively connected to the development cartridges 510, and the developers contained in the developer cartridges 520 are respectively supplied to the development cartridges 510. The developer cartridges 520 and the development cartridges 510 may be individually replaced.

The development cartridges 510 include four development cartridges 510C, 510M, 510Y, and 510K for developing developers with cyan color (C), magenta color (M), yellow color (Y), and black color (K). The developer cartridges 520 contain the developers with cyan color, magenta color, yellow color, and black color, respectively. Unless there is a particular description contrary thereto, items with reference numerals C, M, Y, and K indicate elements for developing the developers with cyan color, magenta color, yellow color, and black color.

Each of the development cartridges 510 may include the photosensitive drum 21 on which an electrostatic latent image is formed, and the developing roller 22 for developing the electrostatic latent image to a visible toner image by supplying the developer from the developer cartridge 520 to the electrostatic latent image. The photosensitive drum 21 is an example of a photosensitive body on which the electrostatic latent image is formed, and may include a conductive metal pipe and a photosensitive layer formed at an outer circumference of the conductive metal pipe. The charging roller 23 is an example of a charger that charges a surface of the photosensitive drum 21 to have a uniform surface potential. Instead of the charging roller 23, a charging brush, a corona charger, or the like may be used.

Although not illustrated, the development cartridges 510 may further a charging roller cleaner for removing foreign substances or dusts attached to a surface of the charging roller 23, a cleaning member for removing residual developers attached to the surface of the photosensitive drum 21 after a transfer process to be described below, and a regulation member for regulating an amount of developer to be supplied to a development area where the photosensitive drum 21 and the developing roller 22 face each other.

In the present embodiment, a two-component developing method is used. In this case, developer contained in the developer cartridge 520 may be a toner, or a toner and a carrier.

When the two-component developing method is used, developer contained in the developer cartridge 520 may be the toner and the carrier. The carrier may be contained in the development cartridge 510. In this case, in order to constantly maintain a ratio of the toner to the carrier in the development cartridge 510, surplus carriers are discharged to the outside of the development cartridge 510 and are contained in a waste developer container (not shown). The developing roller 22 is spaced apart from the photosensitive drum 21 by a distance of several tens to several hundreds of micron. Although not illustrated, the developing roller 22 may include a development sleeve and a magnetic roller that is disposed in the development sleeve. The toner and the carrier are mixed with each other in the development cartridge 510, and the toner is attached onto a surface of a magnetic carrier. The magnetic carrier is attached onto a surface of the developing roller 22 and is delivered to a development area where the photosensitive drum 21 and the developing roller 22 face each other. Due to a developing bias voltage applied to a gap between the developing roller 22 and the photosensitive drum 21, only the toner is supplied to the photosensitive drum 21 so that the electrostatic latent image formed on a surface of the photosensitive drum 21 is developed to a visible image.

An exposure device 550 forms the electrostatic latent image on the photosensitive drum 21 by irradiating light to the photosensitive drum 21, the light being modulated according to image information. Examples of the exposure device 550 may include an LSU using a laser diode as a light source, an LED exposure device using an LED as a light source, or the like.

An intermediate transfer belt 560 temporarily receives a toner image developed on the photosensitive drum 21 of each of the development cartridges 510C, 510M, 510Y, and 510K. A plurality of intermediate transfer rollers 561 are positioned to face the photosensitive drums 21 of the development cartridges 510C, 510M, 510Y, and 510K by interposing the intermediate transfer belt 560 therebetween. An intermediate transfer bias voltage is applied to the intermediate transfer rollers 561 so as to intermediately transfer images, which are developed on the photosensitive drums 21, to the intermediate transfer belt 560. Instead of the intermediate transfer rollers 561, a corona transfer device or a pin scorotron-type transfer device may be used.

A transfer roller 570 is positioned to face the intermediate transfer belt 560. A transfer bias voltage is applied to the transfer roller 570 so as to transfer, to a recording medium P, the toner images that are transferred to the intermediate transfer belt 560.

A fixing device 580 fixes the toner image on the recording medium P by applying heat and/or pressure to the toner image that has been transferred onto the recording medium P. A form of the fixing device 580 is not limited to an example shown in FIG. 15.

According to the aforementioned structure, the exposure device 550 scans a plurality of lights, each of which being modulated according to image information of each color, to the photosensitive drums 21 of the development cartridges 510C, 510M, 510Y, and 510K, and forms electrostatic latent images on the photosensitive drums 21. Due to C, M, Y, and K developers supplied from the developer cartridges 520C, 520M, 520Y, and 520K to the development cartridges 510C, 510M, 510Y, and 510K, the electrostatic latent images on the photosensitive drums 21 of the development cartridges 510C, 510M, 510Y, and 510K are developed to visible toner images. The developed toner images are intermediately transferred to the intermediate transfer belt 560 in a sequential order. The recording medium P loaded in a paper-feeding member 590 is transported along a paper-feeding path 591 to a portion between the transfer roller 570 and the intermediate transfer belt 560. Due to a transfer bias voltage applied to the transfer roller 570, the toner images that have been intermediately transferred onto the intermediate transfer belt 560 are transferred onto the recording medium P. When the recording medium P passes through the fixing device 580, the toner images are fixed on the recording medium P due to heat and a pressure. The recording medium P for which fixing is completed is externally discharged by a discharging roller 592.

The development cartridge 510 and the developer cartridge 520 are detachably attached to a main body 500. Developer contained in the developer cartridge 520 is supplied to the development cartridge 510. When the developer contained in the developer cartridge 520 is completely used, the developer cartridge 520 may be replaced with a new developer cartridge, or a new developer may be filled in the developer cartridge 520. In order to stably supply the developer to the development cartridge 510, a developer supply unit 530 may be arranged between the developer cartridge 520 and the development cartridge 510. The developer supply unit 530 receives developer from the developer cartridge 520, contains a predetermined amount of the developer, and delivers the contained developer to the development cartridge 510. A supply pipe line 540 connects the developer supply unit 530 to the development cartridge 510.

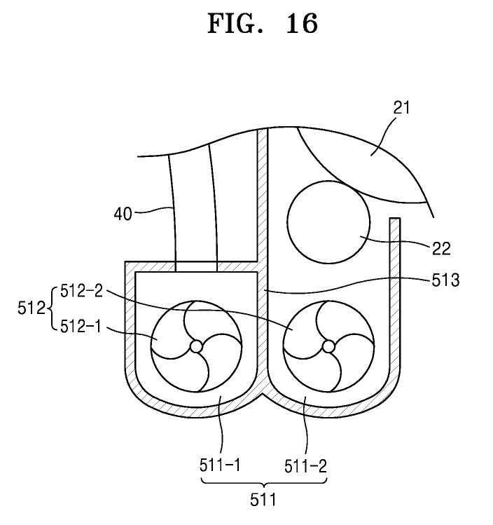

The developer that is supplied to the inside of the development cartridge 510 via the supply pipe line 540 is sufficiently stirred and is supplied to the developing roller 22. FIG. 16 illustrates a cross-sectional view of a portion of the development cartridge 510, according to an embodiment. Referring to FIG. 16, a toner and a carrier are mixed with each other while they are delivered in an axial direction of the developing roller 22 in an internal space of the development cartridge 510, i.e., a stirring chamber 511. In this process, the toner is charged by friction with the carrier. In the stirring chamber 511, at least one stirrer 512 is arranged to mix and stir the developer and to transport the developer in a direction parallel to the axial direction of the developing roller 22.

The stirring chamber 511 may include first and second stirring chambers 511-1 and 511-2 that extend in the axial direction of the developing roller 22 and are parallel to each other. The stirrer 512 may include a first stirrer 512-1 installed in the first stirring chamber 511-1, and a second stirrer 512-2 installed in the second stirring chamber 511-2. The first and second stirring chambers 511-1 and 511-2 are separated from each other by a partition 513 extending in the axial direction of the developing roller 22. First and second openings (not shown) are respectively formed in both longitudinal-direction ends of the partition 513, i.e., the ends being in the axial direction of the developing roller 22. The first and second stirring chambers 511-1 and 511-2 are connected to each other via the first and second openings. For example, the first and second stirrers 512-1 and 512-2 may each be an auger having an axis extending in the axial direction of the developing roller 22 and spiral wings formed at an outer circumference of the axis.

When the first stirrer 512-1 rotates, developer in the first stirring chamber 511-1 is delivered in the axial direction by the first stirrer 512-1, and then is delivered to the second stirring chamber 511-2 via the first opening formed near one end of the partition 513. Developer in the second stirring chamber 511-2 is delivered by the second stirrer 512-2 in an opposite direction to the delivery direction by the first stirrer 512-1, and is delivered to the first stirring chamber 511-1 via the second opening formed near the other end of the partition 513. By doing so, the developer is circulated throughout the first and second stirring chambers 511-1 and 511-2, and in the circulation process, the developer is supplied to the developing roller 22 in the second stirring chamber 511-2.

In the image forming apparatus using the two-component developing method, a toner is sufficiently charged while circulating in the stirring chamber 511 and then is transferred as an electrostatic latent image on the photosensitive drum 21. When the image forming apparatus is initially driven or a long time elapses after printing, charge of the toner may be reduced. When printing is performed in this state, the toner with low charge may not be developed to an electrostatic latent image on the photosensitive drum 21 and may be scattered to the outside of the development cartridge 510. Therefore, it is necessary to sufficiently charge the toner by circulating the toner with a carrier in the stirring chamber 511 by driving the stirrer 512. In this regard, when the developing roller 22 rotates along with the stirrer 512, the toner may be scattered. Thus, when the stirrer 512 is driven to charge the toner, it is required to ban the developing roller 22 from rotating, and to do so, the power delivery members 50, 50a, 50b, and 50c shown in FIGS. 3 through 10 may be used.

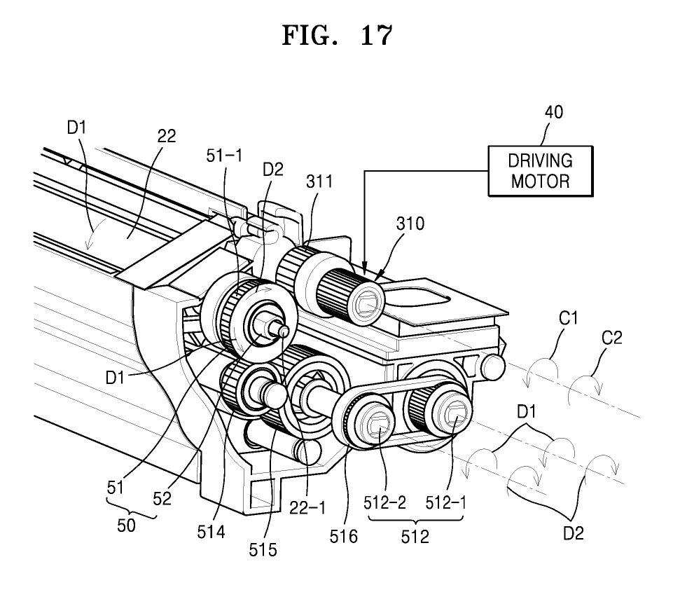

FIG. 17 illustrates a perspective view of a portion of the development cartridge 510, according to an embodiment. FIG. 17 particularly illustrates only the developing roller 22 and the stirrer 512 in detail. Referring to FIG. 17, the coupler (the driving power receiving member) 310 is arranged at the development cartridge 510. When the development cartridge 510 is mounted to the main body 500, the coupler 310 is connected to the driving motor 40 and rotates in the first direction C1 and the second direction C2 when the driving motor 40 is driven in a forward direction and a reverse direction, respectively.

The power delivery member 50 is arranged between the developing roller 22 and the coupler 310. In the present embodiment, the power delivery member 50 is used, but the power delivery member 50a, 50b, or 50c may be used. The first gear 311 of the coupler 310 is engaged with the second gear 51-1 of the power delivery member 50. The second gear 51-1 is connected to a gear 515 via an idle gear 514, the gear 515 being coupled to a rotation axis of the first stirrer 512-1. The first stirrer 512-1 and the second stirrer 512-2 are connected to each other by using a timing belt 516.

During a printing operation, the driving motor 40 is driven in a forward direction, and the coupler 310 rotates in the first direction C1. Then, the developing roller 22 rotates in the forward direction D1 by the power delivery member 50, and the first and second stirrers 512-1 and 512-2 also rotate in the forward direction D1. A toner and a carrier are circulated together throughout the first and second stirring chambers 511-1 and 511-2, and a charged toner passes through the developing roller 22 and then is developed to an electrostatic latent image formed on the photosensitive drum 21.

When the image forming apparatus is initially driven or a long time elapses after printing, the driving motor 40 is driven and in a reverse direction and the coupler 310 rotates in the second direction C2 so as to charge a toner. Then, torque of the coupler 310 in the second direction C2 is blocked by the power delivery member 50, and the developing roller 22 does not rotate. The second gear 51-1 rotates in the reverse direction D2, and the first and second stirrers 512-1 and 512-2 connected to the second gear 51-1 also rotate in the reverse direction D2. A toner and a carrier are circulated together throughout the first and second stirring chambers 511-1 and 511-2 in a direction opposite to a circulation direction when the first and second stirrers 512-1 and 512-2 rotate in the forward direction D1, and the toner is charged.

When the toner is sufficiently charged, the driving motor 40 is forwardly driven to perform a printing operation. The coupler 310 rotates in the first direction C1, and the developing roller 22 and the first and second stirrers 512-1 and 512-2 also rotate in the forward direction D1.

As described above, by using the power delivery members 50, 50a, 50b, and 50c, the developing roller 22 is banned from rotating while a toner is charged, so that it is possible to prevent the toner from being scattered.

According to the embodiments of the development cartridge and the electrophotographic image forming apparatus, a driving power to be delivered to a developing roller may be blocked to ban the developing roller from rotating while the image forming apparatus is driven in a reverse direction. Accordingly, damage to parts and a leakage of a toner which are caused by the reverse-direction rotation of the developing roller, and deterioration of a printing quality due to the damage and the leakage may be prevented.

While this disclosure has been particularly shown and described with reference to the embodiments thereof, it will be understood by one of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

What is claimed is:

1. A development cartridge capable of being detachably attached to a main body of an image forming apparatus, the development cartridge comprising:
a developing roller;
a driving power receiving member to rotate in a first direction or a second direction by receiving a driving power from the main body when the development cartridge is attached to the main body; and
a power delivery member to couple the driving power receiving member to the developing roller, the power delivery member to:
engage the developing roller with the driving power receiving member to deliver torque of the driving power receiving member rotating in the first direction to the developing roller, and
disengage the developing roller from the driving power receiving member to stop delivering the torque of the driving power receiving member, in response to a rotation of the driving power receiving member in the second direction.

2. The development cartridge of claim 1, wherein the power delivery member comprises:
a rotational member comprising a first latch, the rotational member to be rotated by the driving power receiving member to axially reciprocate between a first position and a second position as the driving power receiving member rotates in the first direction and the second direction, respectively; and
a delivery member comprising a second latch having a form complementary with a form of the first latch, the delivery member to deliver the torque of the driving power receiving member rotating in the first direction to the developing roller by the first latch couples to the second latch when the rotational member is positioned at the first position.

3. The development cartridge of claim 2, wherein
the first latch comprises a female screw,
the second latch comprises a male screw coupleable to and decoupleable from the female screw, such that:
when the driving power receiving member rotates in the first direction, the male screw couples to the female screw to engage the developing roller with the driving power receiving member to deliver the torque to rotate the developing roller, and
when the driving power receiving member rotates in the second direction, the male screw is decoupled from the female screw to disengage the developing roller from the driving power receiving member to stop delivering the torque of the driving power receiving member.

4. The development cartridge of claim 3, wherein the delivery member couples to the developing roller with respect to a rotation axis of the developing roller.

5. The development cartridge of claim 3, wherein the delivery member comprises a rotation axis of the developing roller, wherein the male screw is formed at a side of the rotation axis.

6. The development cartridge of claim 3, wherein:
the driving power receiving member comprises a first gear,
the rotational member further comprises a second gear coupled to the first gear, and
the first gear and the second gear are helical gears to generate thrust in a direction toward where the rotational member is moved to the first position when the driving power receiving member rotates in the first direction.

7. The development cartridge of claim 2, wherein
the delivery member couples to the developing roller with respect to a rotation axis of the developing roller,
the first latch and the second latch respectively have concavo-convex shapes that are complementary in the axial direction, so that:
the first latch is engaged with the second latch when the rotational member is positioned at the first position, and
the first latch is disengaged from the second latch when the rotational member is positioned at the second position,
the driving power receiving member comprises a first gear,
the rotational member further comprises a second gear coupled to the first gear, and
the first gear and the second gear are helical gears to generate thrust in a direction toward where the rotational member is moved to the first position when the driving power receiving member rotates in the first direction.

8. The development cartridge of claim 1, wherein the power delivery member comprises:
a first rotational member to couple to the developing roller, the first rotational member comprising a guiding portion and a latch;
a second rotational member comprising an inner gear, the second rotational member to be mounted on a same axis as the first rotational member and to rotate by being coupled to the driving power receiving member; and
a latch gear to be mounted at the guiding portion while being engaged with the inner gear, so that:
when the driving power receiving member rotates in the first direction, the latch gear moves along the guiding portion to an engaged position where the latch gear is to be engaged with the latch so as to allow the first rotational member and the second rotational member to rotate together, to engage the developing roller with the driving power receiving member to deliver torque of the driving power receiving member, and
when the driving power receiving member rotates in the second direction, the latch gear moves along the guiding portion to a disengaged position where the latch gear is spaced apart from the latch, to disengage the developing roller from the driving power receiving member to stop delivering the torque of the driving power receiving member.

9. The development cartridge of claim 1, further comprising:
a photosensitive drum to form a development nip by contacting the developing roller; and
a development nip releasing member configured to move the developing roller to be spaced apart from the photosensitive drum to release the development nip when the driving power receiving member rotates in the second direction.

10. The development cartridge of claim 9, wherein, when the driving power receiving member rotates in the first direction, the development nip releasing member moves the developing roller to contact the photosensitive drum to form the development nip.

11. The development cartridge of claim 1, further comprising:
a stirring chamber containing developer; and
a stirrer provided in the stirring chamber to stir the developer,
wherein the stirrer is driven by being connected to the driving power receiving member.

12. The development cartridge of claim 11, wherein
the stirring chamber comprises first and second stirring chambers extending in a longitudinal direction of the developing roller and have interconnected ends to form a circulation path, and
the stirrer comprises first and second stirrers that are respectively provided in the first and second stirring chambers to deliver the developer in opposite directions to each other.

13. An electrophotographic image forming apparatus comprising:
a main body; and
the development cartridge being capable of being detachably attached to the main body, the development cartridge comprising:
a developing roller;
a driving power receiving member to rotate in a first direction or a second direction by receiving a driving power from the main body when the development cartridge is attached to the main body; and
a power delivery member to couple the driving power receiving member to the developing roller, the power delivery member to:
engage the developing roller with the driving power receiving member to deliver torque of the driving power receiving member rotating in the first direction to the developing roller, and
disengage the developing roller from the driving power receiving member to stop delivering the torque of the driving power receiving member, in response to a rotation of the driving power receiving member in the second direction.

14. The electrophotographic image forming apparatus of claim 13, wherein the power delivery member comprises:
a rotational member comprising a first latch, the rotational member to be rotated by the driving power receiving member to axially reciprocate between a first position and a second position as the driving power receiving member rotates in the first direction and the second direction, respectively; and
a delivery member comprising a second latch having a form complementary with a form of the first latch, the delivery member to deliver the torque of the driving power receiving member rotating in the first direction to the developing roller by the first latch couples to the second latch when the rotational member is positioned at the first position.

15. The electrophotographic image forming apparatus of claim 14, wherein
the first latch comprises a female screw,
the second latch comprises a male screw coupleable to and decoupleable from the female screw, such that:
when the driving power receiving member rotates in the first direction, the male screw couples to the female screw to engage the developing roller with the driving power receiving member to deliver the torque to rotate the developing roller, and
when the driving power receiving member rotates in the second direction, the male screw is decoupled from the female screw to disengage the developing roller from the driving power receiving member to stop delivering the torque of the driving power receiving member.

16. The electrophotographic image forming apparatus of claim 15, wherein
the driving power receiving member comprises a first gear,
the rotational member further comprises a second gear coupled to the first gear, and
the first gear and the second gear are helical gears to generate thrust in a direction toward where the rotational member is moved to the first position when the driving power receiving member rotates in the first direction.

17. The electrophotographic image forming apparatus of claim 14, wherein
the delivery member couples to the developing roller with respect to a rotation axis of the developing roller,
the first latch and the second latch respectively have concavo-convex shapes that are complementary in the axial direction, so that:
the first latch is engaged with the second latch when the rotational member is positioned at the first position, and
the first latch is disengaged from the second latch when the rotational member is positioned at the second position,
the driving power receiving member comprises a first gear,
the rotational member further comprises a second gear coupled to the first gear, and
the first gear and the second gear are helical gears to generate thrust in a direction toward where the rotational member is moved to the first position when the driving power receiving member rotates in the first direction.

18. The electrophotographic image forming apparatus of claim 13, wherein the power delivery member comprises:
a first rotational member couple to the developing roller, the first rotational member comprising a guiding portion and a latch;
a second rotational member comprising an inner gear, the second rotational member to be mounted on a same axis as the first rotational member and to rotate by being coupled to the driving power receiving member; and
a latch gear to be mounted at the guiding portion while being engaged with the inner gear, so that:
when the driving power receiving member rotates in the first direction, the latch gear moves along the guiding portion to an engaged position where the latch gear is to be engaged with the latch so as to allow the first rotational member and the second rotational member to rotate together, to engage the developing roller with the driving power receiving member to deliver torque of the driving power receiving member, and
when the driving power receiving member rotates in the second direction, the latch gear moves along the guiding portion to a disengaged position where the latch gear is spaced apart from the latch, to disengage the developing roller from the driving power receiving member to stop delivering the torque of the driving power receiving member.

19. The electrophotographic image forming apparatus of claim 13, wherein the development cartridge further comprises:
a photosensitive drum to form a development nip by contacting the developing roller; and
a development nip releasing member configured to move the developing roller to be spaced apart from the photosensitive drum to release the development nip when the driving power receiving member rotates in the second direction.

20. The electrophotographic image forming apparatus of claim 19, wherein, when the driving power receiving member rotates in the first direction, the development nip releasing member moves the developing roller to contact the photosensitive drum to form the development nip.
